(19) United States
(12) Patent Application Publication
(10) Pub. No.: US 2018/0166976 A1
(43) Pub. Date: Jun. 14, 2018

(54) POWER FACTOR CORRECTOR WITH REGULATION CIRCUITRY

(71) Applicant: Infineon Technologies Austria AG, Villach (AT)

(72) Inventor: Wanchun Jiang, Shenzen (CN)

(21) Appl. No.: 15/373,362

(22) Filed: Dec. 8, 2016

(51) Int. Cl. H02M 1/42; H02M 3/158; H02M 3/335

(52) U.S. Cl. CPC H02M 1/42; H02M 3/33507; H02M 3/1582

(57) ABSTRACT

A power factor corrector with regulation circuitry. The power factor corrector includes converter circuitry and controller circuitry coupled to the converter circuitry. A switch of the converter circuitry is configured to deliver a signal to the controller circuitry to induce a voltage at an input of the controller circuitry to control conductive state of the switch and at a magnitude that is a function of an input voltage of the converter circuity.

### SUMMARY

The present disclosure is directed to a power factor corrector that, in some examples, may be incorporated into a front end of a switched-mode power supply.

As an example, a power factor corrector circuit may include or comprise converter circuitry that includes a switch, and controller circuitry that is coupled to the converter circuitry, wherein the switch of the converter circuitry is configured to deliver a signal to the controller circuitry to induce a voltage at an input of the controller circuitry to control conductive state of the switch and at a magnitude that is a function of an input voltage of the converter circuity.

As another example, a switched-mode power supply may include or comprise a filter, a power converter that includes a switch, and a power factor corrector circuit that is configured to receive an AC half-wave rectified input voltage from the filter and provide a DC output voltage to the power converter, wherein the power factor corrector circuit comprises converter circuitry and controller circuitry, and the switch of the power converter is configured to deliver a signal to the controller circuitry to induce a voltage at an input of the controller circuitry to control conductive state of the switch and at a magnitude that is a function of the AC half-wave rectified input voltage.

As another example, a power factor corrector circuit may include or comprise a power converter that includes a switch, a power factor controller, and a resistive ladder network that is coupled to the power converter and to the power factor controller, wherein a switch of the power converter is configured to deliver current to the power factor controller to induce a voltage at an input of the power factor controller, that is coupled to a node of the resistive ladder network, to control conductive state of the switch and at a magnitude that is a function of an input voltage of the power converter.

Other examples are possible.

### BRIEF DESCRIPTION OF DRAWINGS

FIG. 1 shows a block diagram of a power factor corrector with regulation circuitry according to the disclosure.

FIG. 2 shows voltage and current characteristics of converter circuitry of the power factor corrector of FIG. 1.

FIG. 3 shows a plot of AC input current versus phase angle for the power factor corrector of FIG. 1.

FIG. 4 shows a plot of power factor versus input power for the power factor corrector of FIG. 1.

FIG. 5 shows a plot of total harmonic distortion versus input power for the power factor corrector of FIG. 1.

FIG. 6 shows a hybrid block/schematic diagram of a switched-mode power supply that includes the power factor corrector of FIG. 1.

FIGS. 7-8 show voltage and current characteristics of the power factor corrector of FIG. 6.

FIGS. 9-11 show the switched-mode power supply of FIG. 6, in part, whereby converter circuitry of the power factor corrector of FIG. 6 is arranged as a buck converter (FIG. 9), a buck/boost converter (FIG. 10), and a fly-back converter (FIG. 11), as compared to a boost converter as shown in FIG. 6.

### DETAILED DESCRIPTION

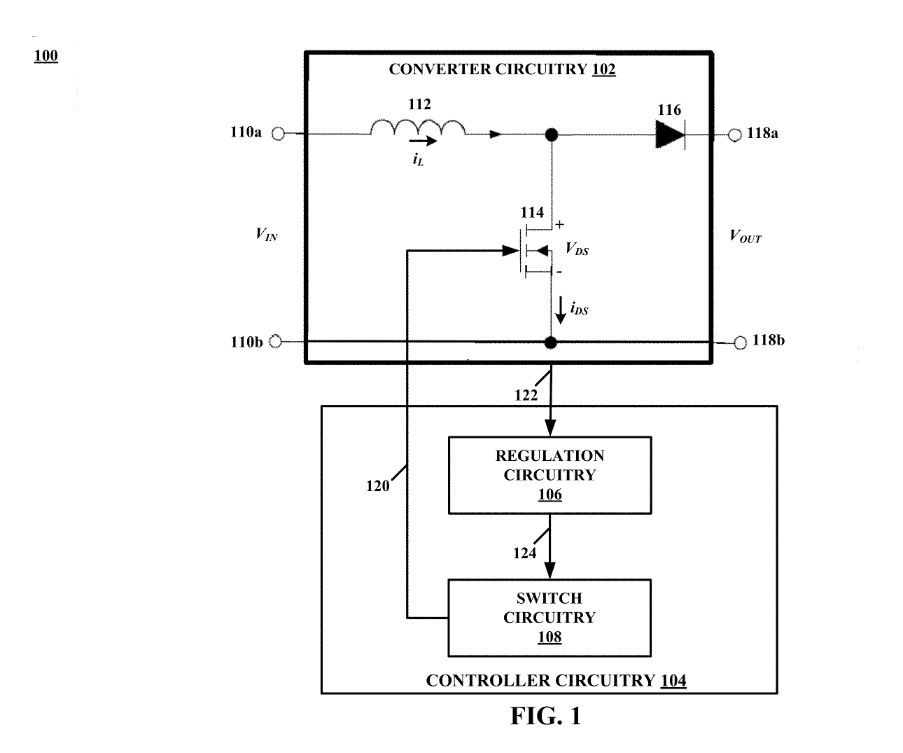

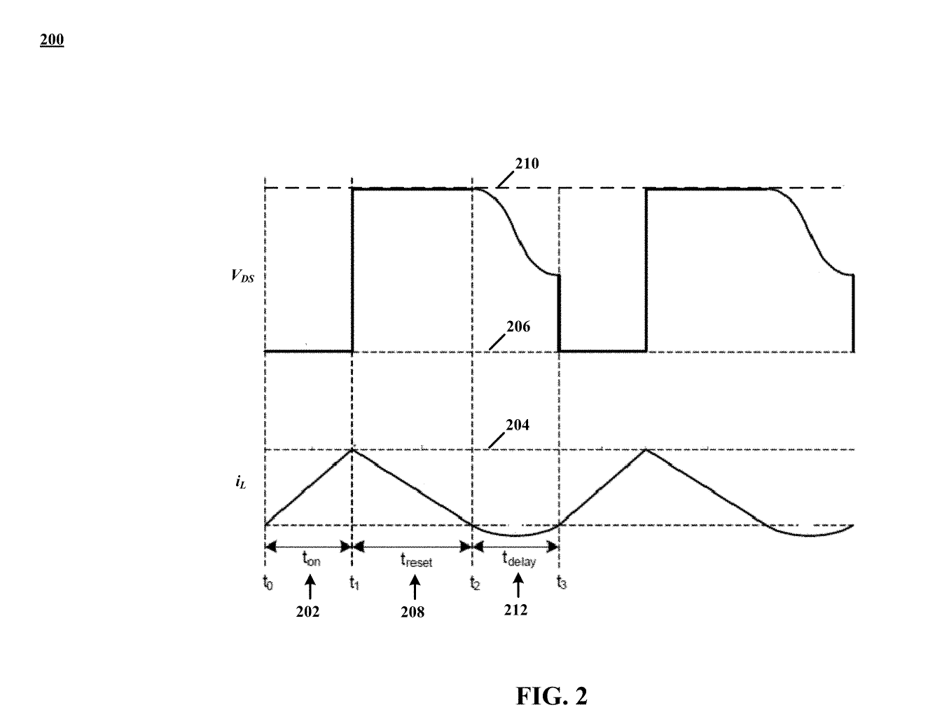

Switched-mode power supplies are an important class of AC/DC power converters. While there are many different architectures, a switched-mode power supply may comprise of, at the front end, a power factor corrector that includes a boost converter and a power factor controller that together function to minimize the phase angle difference between input voltage and current. Each one of power factor and total harmonic distortion, two important and intertwined figures of merit, is a function of phase angle difference between input voltage and current. In particular, power factor approaches unity as the phase angle difference between input voltage and current approaches zero, and total harmonic distortion approaches zero as power factor approaches unity. The relationship between power factor and total harmonic distortion in the context of switched-mode power supplies is discussed in detail in connection with FIGS. 1-2 with reference to a power factor corrector configured and/or arranged in accordance with the principles of the present disclosure.

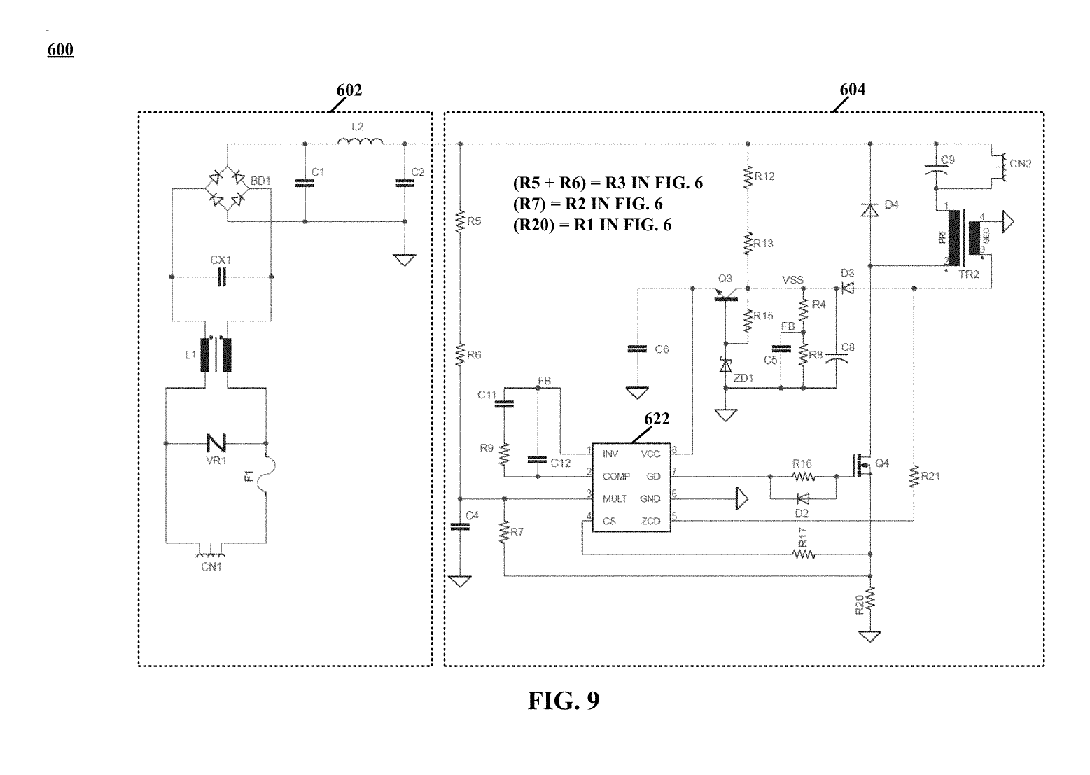

FIG. 1 shows a block diagram of a power factor corrector (PFC) 100 configured and/or arranged in accordance with the principles of the present disclosure. Specifically, PFC 100 comprises converter circuitry 102 and controller circuitry 104, and controller circuitry 104 comprises regulation circuitry 106 and switch circuitry 108. While other power converter topologies are contemplated (see e.g., FIGS. 9-11), converter circuitry 102 is arranged as a boost converter and thus includes a set of input voltage (V_{IN}) pins 110a-b, a choke inductor 112, a switch 114, a boost diode 116, and a set of output voltage (V_{OUT}) pins 118a-b. Further, while switch 114 is depicted as a metal-oxide-semiconductor field-effect transistor, it is contemplated that switch 114 may be realized by or as any component(s) or device(s) capable of operating as an ON/OFF switching element (e.g., metal-semiconductor field-effect transistor, gallium nitride-based switch, bipolar junction transistor-based switch, etc.), where type of switch element may be implementation-specific and may evolve as technology evolves.

In operation, switch circuitry 108 of controller circuitry 104 generates a drive signal 120 that is supplied as input to switch 114, to control ON/OFF state of switch 114. Based on drive signal 120, switch 114 generates a feedback signal 122 that is supplied as input to regulation circuitry 106 of controller circuitry 104. Based on feedback signal 122, regulation circuitry 106 generates a compensation signal 124 that is supplied as input to switch circuitry 108 controller circuitry 104. Based on compensation signal 124, switch circuitry 108 of controller circuitry 104 generates drive signal 120 that is supplied as input to switch 114, to control ON/OFF state of switch 114.

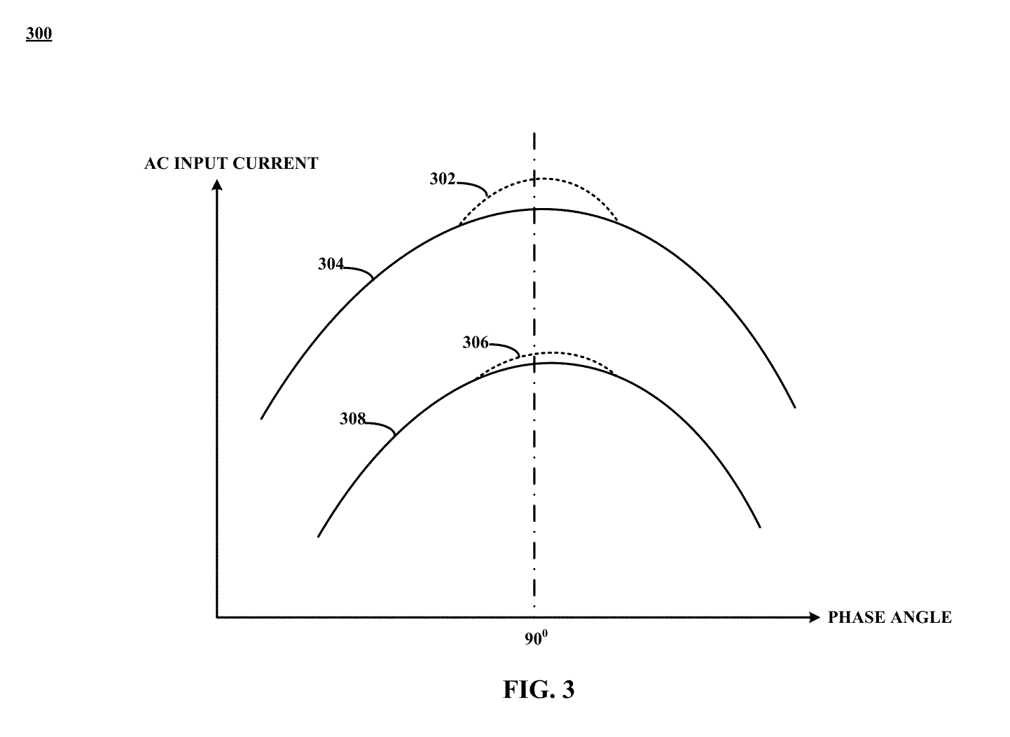

Thus, PFC 100 is configured and/or arranged such that a feedback loop is defined between converter circuitry 102 and controller circuitry 104, whereby regulation circuitry 106 of controller circuitry 104 generates compensation signal 124 based on feedback signal 122, and switch circuitry 108 of controller circuitry 104 generates drive signal 120 based on compensation signal 124. As discussed in detail in connection with FIGS. 3-8, compensation signal 124 serves to minimize the phase angle difference between input voltage and current over a rated range of input voltages for PFC 100 (e.g., 90-285 VAC), thereby improving performance of PFC 100 in terms of power factor (PF) and total harmonic distortion (THD). Drive signal 120 is discussed in connection with FIG. 2, to derive the relationship between PF and THD with reference to PFC 100 of FIG. 1.

With reference to FIGS. 1-2, FIG. 2 shows a plot 200 of voltage drop, VDS, across switch 114, and current, i_{L}, through inductor 112, as switch circuitry 108 generates drive signal 120 to control ON/OFF state of switch 114. During time period tₒₙ 202, switch 114 is in ON state (i.e., low impedance), and admits current to energize inductor 112 such that i_{L} increases linearly to a peak current value 204, and such that VDS is at minimum voltage value 206. During time period tᵣₑₛₑₜ 208, switch 114 is in OFF state (i.e., high impedance), and energy stored by inductor 112 in a magnetic field is released such that i_{L} decreases linearly from peak current value 204, and such that VDS is at a maximum voltage value 210. During time period t_{Delay} 212, i_{L} oscillates freely as a sine wave, which in turn allows V_{DS} to oscillate freely as a sine wave (90° out of phase with i_{L}). Such an implementation may be referred to as “valley switching” which, at the cost increased THD, serves to reduce undesired transients that would normally occur if V_{DS} were switched from maximum voltage value 210 directly to minimum voltage value 206 at onset of a subsequent time period tₒₙ (i.e., at t₃).

Time period tₒₙ is defined as the interval t₀-t₁. At to, switch circuitry 108 switches, via drive signal 120, switch 114 to ON state, and i_{L} increases linearly to peak current value 204. Input voltage V_{IN} may be expressed in terms of the inductance L of inductor 112 and the derivative of inductor current i_{L} with respect to time:

$${V}_{IN} = L \frac{{di}_{L}}{dt} \qquad ( 1 )$$

Rearranging and integrating Equation 1 yields tₒₙ expressed in terms of inductance L, peak current iₚₑₐₖ and input voltage V_{IN}:

$${t}_{on} = L \frac{{i}_{peak}}{{V}_{IN}} \qquad ( 2 )$$

In a peak current control mode, controller circuitry 104 may set iₚₑₐₖ proportional to input voltage V_{IN} at any instantaneous time, i.e., iₚₑₐₖ=k*V_{IN} where k is a proportionality constant. Controller circuitry 104 may then set tₒₙ proportional to the inductance L of inductor 112:

$${t}_{on} = L \frac{{i}_{peak}}{{V}_{IN}} = L \frac{k {V}_{IN}}{{V}_{IN}} = kL \qquad ( 3 )$$

Time period tᵣₑₛₑₜ is defined as the interval t₁-t₂. At t₁, switch circuitry 108 switches, via drive signal 120, switch 114 to OFF state while diode 116 is in forward bias. Current i_{L} is linearly reduced to zero at t₂, and tᵣₑₛₑₜ can be expressed as:

$$\begin{matrix}{V}_{OUT} = {V}_{IN} = L \frac{{di}_{L}}{dt} & ( 4 ) \\ {t}_{reset} = L \frac{{i}_{peak}}{{V}_{OUT} - {V}_{IN}} = L \frac{k {V}_{IN}}{{V}_{OUT} - {V}_{IN}} = \frac{kL}{\frac{{V}_{OUT}}{{V}_{IN}} - 1} & ( 5 )\end{matrix}$$

Time period t_{Delay} is defined as the interval t₂-t₃, whereby both switch 114 and diode 116 are in OFF state, and the inductance L of inductor 112 and the total equivalent capacitance C of converter circuitry 102 resonates with a resonant period of 2π\sqrt{LC}.

In order to have the lowest switching voltage and switching-on loss for a next or subsequent switching cycle (e.g., following t₃) in a critical conduction operating mode (CrCM), controller circuitry 104 implements t_{Delay} to have a finite duration consistent with “valley switching” as introduced above. That is, controller circuitry 104 holds until V_{DS} is at its lowest voltage in its resonant oscillation to activate switch 114, thereby ending t_{Delay} and starting a subsequent tₒₙ. The nadir or valley point in V_{DS} occurs after one half of a resonant oscillation, such that t_{Delay} may be expressed as:

t_{Delay}=½·2π\sqrt{LC}=π\sqrt{LC} (6)

Implementing t_{Delay} serves the goal of reducing the magnitude of switching in V_{DS} from maximum voltage value 210 to minimum voltage value 206 by about 50%, but at the cost of causing harmonic distortion, and worsening the PF and THD performance of PFC 100. PF and THD may be derived as follows.

For controller circuitry 104 operating PFC 100 in CrCM with peak current operating mode, as introduced above, peak current at inductor 112 may be proportional to the AC input voltage, and expressed as proportional to the input voltage, also as a function of the phase angle θ, where k is a proportionality constant, as:

iₚₑₐₖ(θ)=k*V_{IN}(θ) (7)

Accordingly, tₒₙ may be calculated as proportional to the inductance L of the inductor 112:

tₒₙ=k*L (8)

Then, tᵣₑₛₑₜ can be expressed as a function of the phase angle θ in terms of tₒₙ, input voltage V_{IN}(θ), and output voltage V_{OUT} as:

$${t}_{reset} ( θ ) = \frac{{t}_{on} * {V}_{IN} ( θ )}{{V}_{OUT} - {V}_{IN} ( θ )} \qquad ( 9 )$$

Then, the real-time AC input average current iₐᵥₑ, seen from AC input side, can be expressed in terms of the peak current iₚₑₐₖ(θ), tₒₙ, tᵣₑₛₑₜ(θ) and t_{Delay} as:

$${i}_{ave} ( θ ) = \frac{{i}_{peak} ( θ )}{2} * \frac{{t}_{on} + {t}_{reset} ( θ )}{{t}_{on} + {t}_{reset} ( θ ) + {t}_{Delay}} \qquad ( 10 )$$

Thus, the overall AC input root mean square (RMS) current I_{RMS}, seen from the AC input side, can be derived by integrating the average current iₐᵥₑ over the phase angle, and results as:

$${I}_{RMS} = \sqrt{\frac{{\int }_{0}^{180} {{i}_{ave} ( θ )}^{2} d θ}{180}} \qquad ( 11 )$$

Based on the real-time AC input average current iₐᵥₑ, as expressed in Equation 10, the AC input power Pᵢₙ may be given by integrating the average current iₐᵥₑ and the input voltage Vᵢₙ(θ) over the phase angle, and results as:

$${P}_{in} = \frac{{\int }_{0}^{180} {i}_{ave} ( θ ) * {V}_{in} ( θ ) d θ}{180} \qquad ( 12 )$$

Since only the fundamental component of the AC input current I₁ₛₜ_{_}_{RMS} contributes to the active AC input power, the AC input current fundamental component I₁ₛₜ_{_}_{RMS} may be defined as the ratio of the AC input power Pᵢₙ and the input RMS voltage Vᵢₙ_{_}_{Rms} as:

$${I}_{1 st\_RMS} = \frac{{P}_{in}}{{V}_{in\_RMS}} \qquad ( 13 )$$

Based on above equation (11) and (12), PF can be expressed in terms of the AC input current fundamental component I₁ₛₜ_{_}_{RMS} and the AC input RMS current I_{RMS} as:

$$PF = \frac{{I}_{1 st\_RMS}}{{I}_{RMS}} \qquad ( 14 )$$

Accordingly, THD can be expressed in the same terms as PF as:

$$T H D = \frac{\sqrt{{I}_{RMS}^{2} - {I}_{1 st\_RMS}^{2}}}{{I}_{1 st\_RMS}} = \sqrt{{( \frac{1}{PF} )}^{2} - 1} \qquad ( 15 )$$

Thus, drive signal 120 as introduced in FIG. 1 serves as basis to derive the relationship between PF and THD with reference to PFC 100. This is because ON/OFF state of switch 114 through (repeating) sequence tₒₙ, tᵣₑₛₑₜ and t_{Delay} is controlled by switch circuitry 108 via drive signal 120, and tₒₙ, tᵣₑₛₑₜ and t_{Delay} serve as basis for derivation of THD in terms of PF. However, as mentioned above, switch circuitry 108 of generates drive signal 120 based on compensation signal 124. Advantageously, compensation signal 124 serves to minimize the phase angle difference between input voltage and current over a rated range of input voltages for PFC 100, thereby improving performance of PFC 100 in terms of PF and THD. FIGS. 3-5 illustrate improved performance of PFC 100 by comparison of several plots that show performance of PFC 100 with and without regulation circuitry 106 or, equivalently, with and without the benefit of compensation signal 124.

FIG. 3 shows a plot 300 of AC input current versus phase angle for PFC 100 of FIG. 1 with and without regulation circuitry 106 or, equivalently, with and without the benefit of compensation signal 124. At high-line input voltage (e.g., 285 VAC) or, equivalently, the maximum input voltage of a rated range of input voltages for PFC 100 (e.g., 90-285 VAC), peak AC input current is reduced from that as shown by curve 302 (approximated shape/form), centered around 90° phase angle, to that as shown by curve 304 (approximated shape/form). At low-line input voltage (e.g., 90 VAC) or, equivalently, the minimum input voltage of the rated range of input voltages for PFC 100 (e.g., 90-285 VAC), peak AC input current is reduced from that as shown by curve 306 (approximated shape/form), centered around 90° phase angle, to that as shown by curve 308 (approximated shape/form), although the degree or extent (exaggerated in FIG. 3) by which peak AC input current is reduced at low-line input voltage is less than that by which peak AC input current is reduced at high-line input voltage. Advantageously, such a reduction in peak AC input current directly translates into improved performance of PFC 100 in terms of PF and THD.

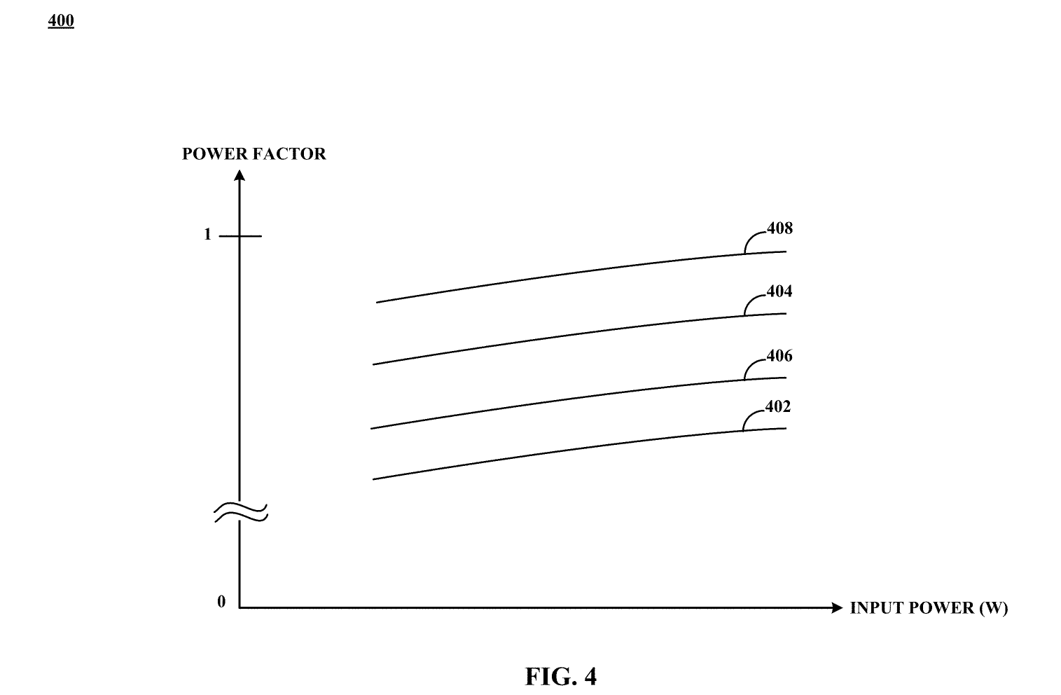

FIG. 4 shows a plot 400 of PF versus input power for PFC 100 of FIG. 1 with and without regulation circuitry 106 or, equivalently, with and without the benefit of compensation signal 124. At high-line input voltage (e.g., 285 VAC) or, equivalently, the maximum input voltage of the rated range of input voltages for PFC 100 (e.g., 90-285 VAC), PF performance of PFC 100 is improved as indicated by the shift along the y-axis towards PF=1 from curve 402 (approximated shape/form) to curve 404 (approximated shape/form), whereby curve 402 is associated with PF performance of PFC 100 without regulation circuitry 106, and curve 404 is associated with PF performance of PFC 100 with regulation circuitry 106. Similarly, at low-line input voltage (e.g., 90 VAC) or, equivalently, the minimum input voltage of the rated range of input voltages for PFC 100 (e.g., 90-285 VAC), PF performance of PFC 100 is improved as indicated by the shift along the y-axis towards PF=1 from curve 406 (approximated shape/form) to curve 408 (approximated shape/form), whereby curve 406 is associated with PF performance of PFC 100 without regulation circuitry 106, and curve 408 is associated with PF performance of PFC 100 with regulation circuitry 106.

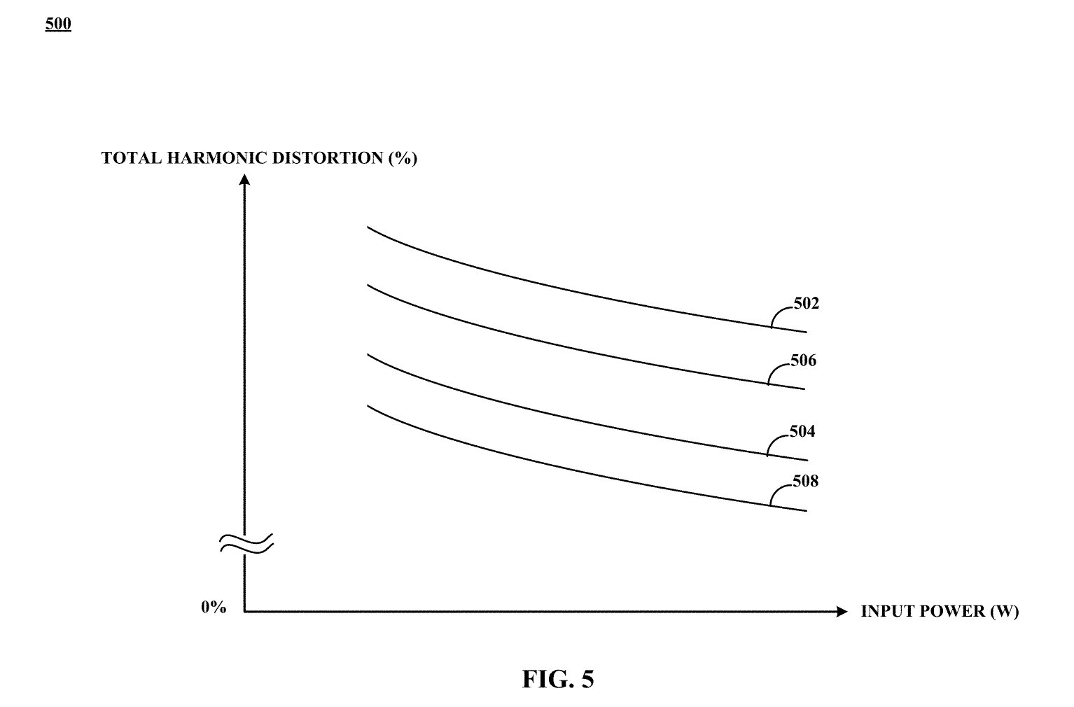

FIG. 5 shows a plot 500 of THD versus input power for PFC 100 of FIG. 1 with and without regulation circuitry 106 or, equivalently, with and without the benefit of compensation signal 124. At high-line input voltage (e.g., 285 VAC) or, equivalently, the maximum input voltage of the rated range of input voltages for PFC 100 (e.g., 90-285 VAC), THD performance of PFC 100 is improved as indicated by the shift along the y-axis towards THD=0% from curve 502 (approximated shape/form) to curve 504 (approximated shape/form), whereby curve 502 is associated with THD performance of PFC 100 without regulation circuitry 106, and curve 504 is associated with THD performance of PFC 100 with regulation circuitry 106. Similarly, at low-line input voltage (e.g., 90 VAC) or, equivalently, the minimum input voltage of the rated range of input voltages for PFC 100 (e.g., 90-285 VAC), THD performance of PFC 100 is improved as indicated by the shift along the y-axis towards THD=0% from curve 506 (approximated shape/form) to curve 508 (approximated shape/form), whereby curve 506 is associated with THD performance of PFC 100 without regulation circuitry 106, and curve 508 is associated with THD performance of PFC 100 with regulation circuitry 106. In practice, PFC 100 may be incorporated into a switched-mode power supply (SMPS), and the improved performance of PFC 100 in terms of PF and THD due to the inclusion of regulation circuitry 106 as illustrated in FIGS. 3-5 may directly translate into improved SMPS performance.

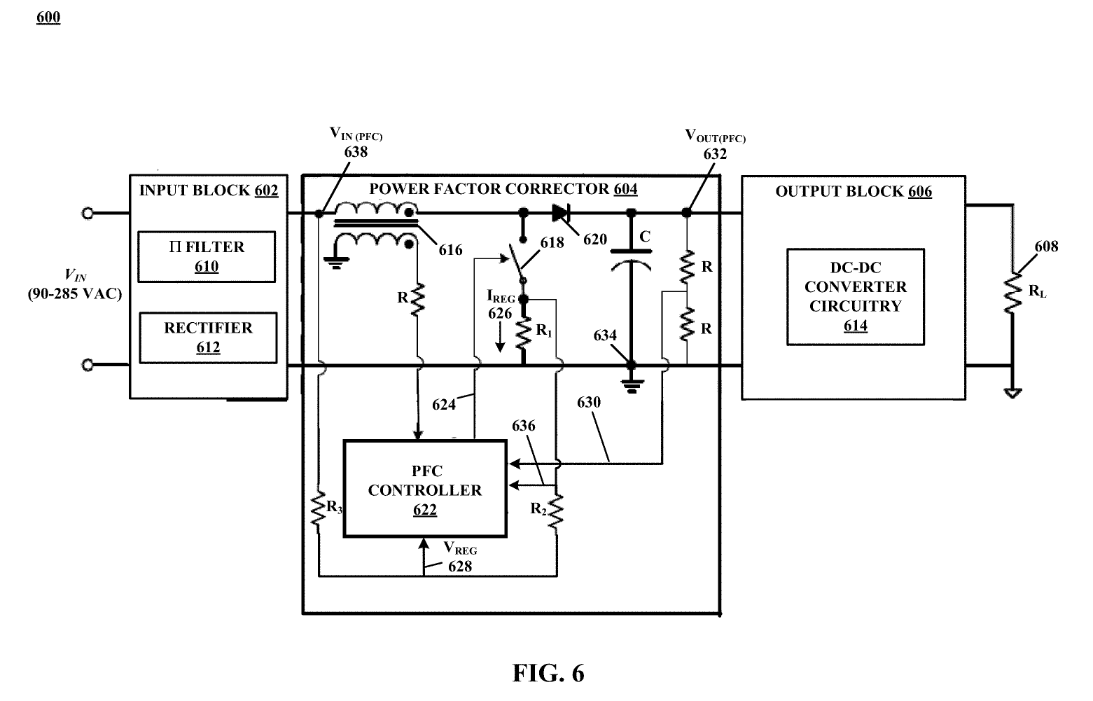

FIG. 6 shows a hybrid block/schematic diagram of a SMPS 600 that includes PFC 100 of FIG. 1, labeled in FIG. 6 as PFC 604. Specifically, SMPS 600 comprises an input block 602, PFC 604, an output block 606 and a load 608. Input block 602 generally comprises a capacitor-input (π) filter 310 (e.g., 1 mF+1 mH+0.47 mF), for electromagnetic interference concerns, and AC half-wave rectifier circuitry 612. Output block 606 generally comprises DC-DC converter circuitry 614, and is connected to load 608 that typically exhibits a variable effective resistance.

In this example, PFC 604 comprises a boost converter that itself includes a choke inductor 616, a switch 618, a boost diode 620, and a set of resistors R and a bulk capacitor C, that together correspond to converter circuitry 102 of PFC 100 as shown in FIG. 1. PFC 604 further comprises a PFC controller 622 and a set of resistors R1, R2 and R3 that together correspond to controller circuitry 104 of PFC 100 as shown in FIG. 1. More specifically, PFC controller 622 corresponds to switch circuitry 108 of PFC 100. And, although the present disclosure is not so limited, PFC controller 622 may be realized as the TDA4863 Power Factor Controller from Infineon Technologies of Neubiberg, Germany. Additionally, the set of resistors R1, R2 and R3 corresponds to regulation circuitry 106 of PFC 100 as shown in FIG. 1, and in practice may be realized as any number of resistors that exhibit an appropriate equivalent series resistance as arranged in a voltage divider topology.

In operation, PFC controller 622 generates a drive signal 624 that is supplied as input to switch 618, to control ON/OFF state of switch 618. Based on drive signal 624, switch 618 generates a feedback signal (I_{REG}) 626 that is supplied as input to R1. Based on feedback signal 626, the resistive ladder network (i.e., voltage divider) formed by the set of resistors R1, R2 and R3 (i.e., regulation circuitry 106 of PFC 100) generates a compensation signal (V_{REG}) 628 that is supplied as input to PFC controller 622. Based on compensation signal 628, PFC controller 622 generates drive signal 624 that is supplied as input to switch 618, to control ON/OFF state of switch 618.

Thus, PFC 604 is configured and/or arranged such that a feedback loop is defined between switch 618 and PFC controller 622, whereby the resistive ladder network formed by the set of resistors R1, R2 and R3 generates compensation signal 628 based on feedback signal 626, and PFC controller 622 generates drive signal 624 based on compensation signal 628. With reference to above-discussion provided in connection with FIGS. 3-5, compensation signal 628 serves to minimize the phase angle difference between input voltage and current over a rated range of input voltages for PFC 604 (e.g., 90-285 VAC), thereby improving performance of PFC 604 in terms of PF and THD.

Table 1 below includes a set of data that illustrates performance of PFC 604 in terms of PF and THD with and without the benefit of compensation signal 628 (i.e., compensation signal 124). With the benefit of compensation signal 628, the topology of PFC 604 would be as illustrated in FIG. 6, whereby R2 is series-connected with R3 and R1. Without the benefit of compensation signal 628, the topology of PFC 604 would be such that R2 is series-connected with R3 and a ground node of PFC 604.

TABLE 1

| Input | Load | Output | | | Circuit |
|---|---|---|---|---|---|
| (PFC) | condition | (PFC) | THD | PF | Connection |
| 285 VAC | 70% | 23.6 V/6.3 A | 24.9% | 0.88 | Connect R2 to |
| | | | | | GND; R2 = |
| | | | | | 47 kΩ |
| 88.2 VAC | 100% | 34.6 V/6.3 A | 4.8% | 0.998 | Connect R2 to |
| | | | | | GND; R2 = |
| | | | | | 47kR |
| 285 VAC | 70% | 23.6 V6.3 A | 13.1% | 0.940 | Connect R2 |
| | | | | | to R1; R2 = |
| | | | | | 30 kΩ |
| 88.2 VAC | 100% | 34.6 V/6.3 A | 3.3% | 0.999 | Connect R2 |
| | | | | | to R1; R2 = |
| | | | | | 30 kΩ |

Table 1, above, includes a set of data that illustrates performance of PFC 604 in terms of PF and THD with (bottom two rows) and without (top two rows) the benefit of compensation signal 628. As may be understood upon inspection of Table 1, performance of PFC 604 in terms of PF and THD is improved with the benefit of compensation signal 628. In practice, ohmic values for each one of resistor R1, R2 and R3 may be selected so as to “tune” the response of PFC 604. However, such values should be selected so as to insure that PFC 604 operates correctly over the rated range of input voltages for PFC 100 (e.g., 90-285 VAC).

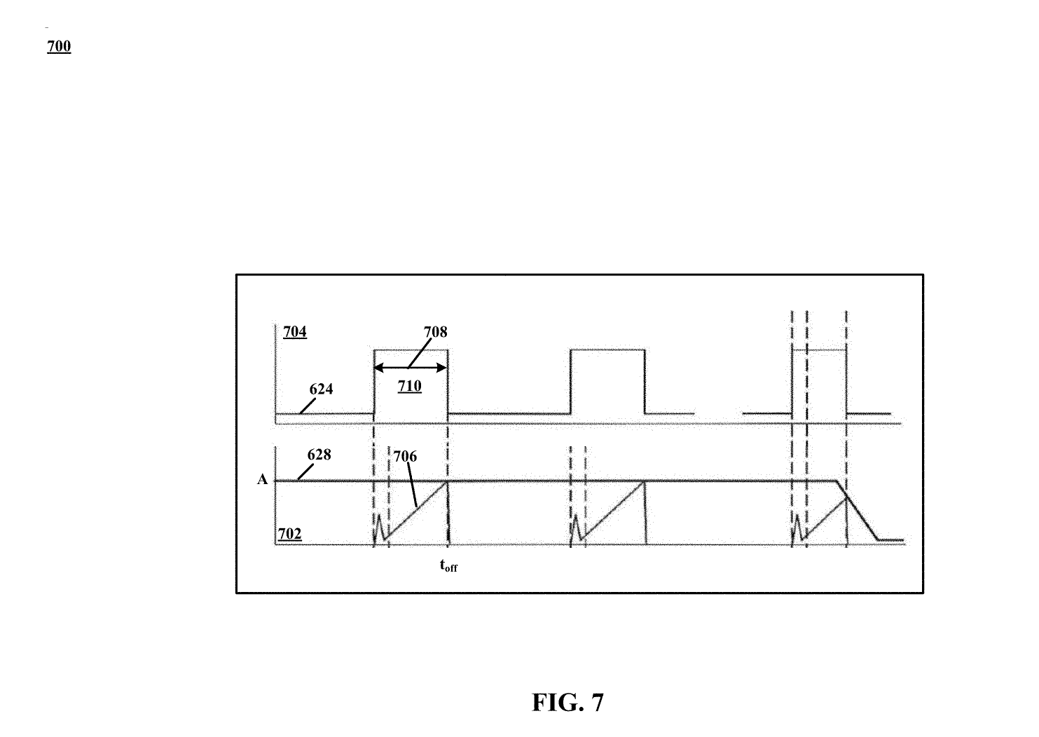

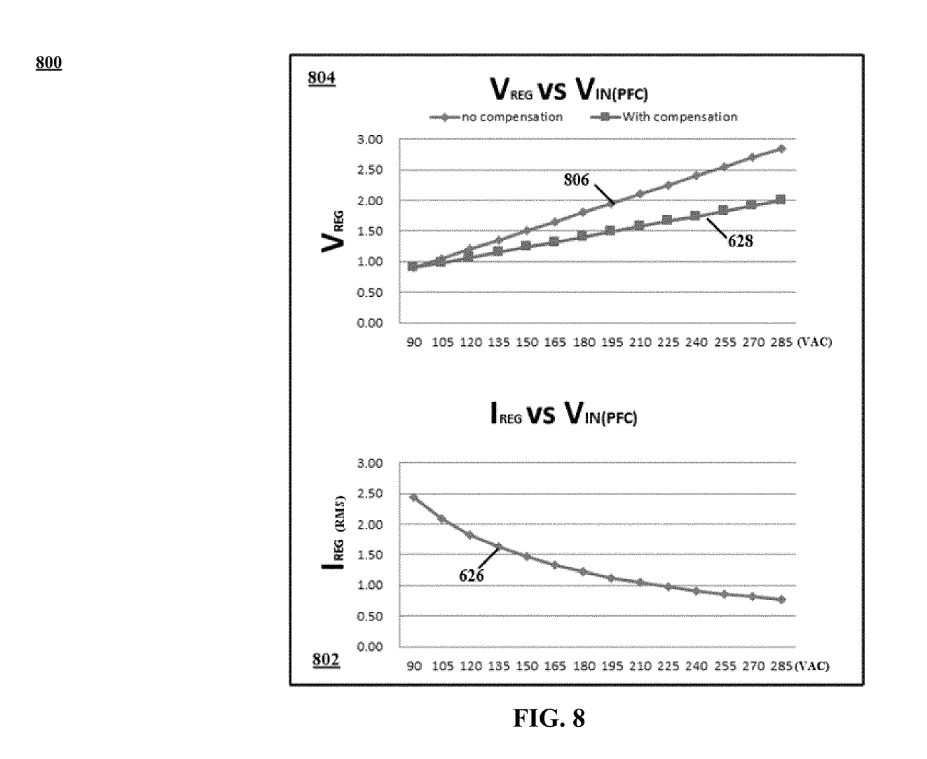

As mentioned above, PFC controller 622 generates drive signal 624 that is supplied as input to switch 618, to control ON/OFF state of switch 618. Based on drive signal 624, switch 618 generates feedback signal (I_{REG}) 626 that is supplied as input to R1. Based on feedback signal 626, the resistive ladder network (i.e., voltage divider) formed by the set of resistors R1, R2 and R3 (i.e., regulation circuitry 106 of PFC 100) generates compensation signal (V_{REG}) 628 that is supplied as input to PFC controller 622. Based on compensation signal 628, PFC controller 622 generates drive signal 624 that is supplied as input to switch 618, to control ON/OFF state of switch 618. FIG. 7 shows a plot that illustrates the relationship between drive signal 624 and compensation signal 628. FIG. 8 shows a plot that illustrates the relationship between feedback signal 626 and compensation signal 628.

FIG. 7 shows a plot 702 (bottom, voltage versus time) of compensation signal 628 aligned temporally with a plot 704 (top, voltage versus time) of drive signal 624. With reference to FIGS. 6-7, compensation signal 628 is transformed by PFC controller 622 (e.g., via mathematical multiplication) to a voltage value A (see FIG. 7) based on a voltage signal 630 (see FIG. 6) that corresponds to a scaled-version of a DC voltage that is developed at an output voltage pin 632 of PFC 604 with reference to ground node 634 of PFC 604. Further, a current signal (I_{SENSE}) 636 is transformed by PFC controller 622 (e.g., via mathematical multiplication, Ohm's Law) to a voltage signal 706 (see FIG. 7) that corresponds to a scaled-version of a DC voltage that is developed across resistor R1 with reference to ground node 634 of PFC 604. In this example, a width 708 of a pulse 710 (see FIG. 7) of drive signal 624 is defined based upon a comparison between voltage signal 706 and compensation signal 628 (voltage value A). In this way, drive signal 624 is generated by PFC controller 622 to control state of switch 618 (i.e., ON/OFF state) based on compensation signal 628. Specifically, when magnitude of voltage signal 706 reaches magnitude of voltage value A, as indicated at time t_{off} in FIG. 7, PFC controller 622 switches drive signal 624 to LOW, which in turn controls switch 618 to OFF state (i.e., high impedance).

FIG. 8 shows a plot 802 (bottom) of feedback signal (I_{REG}) 626, and a plot 804 (top) of compensation signal (V_{REG}) 628, versus instantaneous magnitude of an AC half-wave rectified voltage (V_{IN(PFC)}) that is developed at an input voltage pin 638 of PFC 604 (see FIG. 6). In general, I_{REG} 626 is inversely proportional to V_{IN(PFC)} that is developed at input voltage pin 638 of PFC 604, and V_{REG} 628 is proportional to V_{IN(PFC)} that is developed at input voltage pin 638 of PFC 604.

As mentioned above, with the benefit of compensation signal 628, the topology of PFC 604 would be as illustrated in FIG. 6, whereby R2 is series-connected with R3 and R1. Without the benefit of compensation signal 628, the topology of PFC 604 would be such that R2 is series-connected with R3 and ground node of PFC 604. In the latter scenario, voltage V_{REG} would still be developed at the node between R2 and R3, and would have the form as shown by curve 806 in FIG. 8. Thus, over the rated range of input voltages for PFC 604 (e.g., 90-285 VAC) as shown in FIG. 8, magnitude of V_{REG} as developed at the node between R2 and R3 with R2 series-connected with R3 and R1 increasingly diverges (to lower values with increasing input voltage) from magnitude of V_{REG} as developed at the node between R2 and R3 with R2 series-connected with R3 and ground node of PFC 604 as indicated by curve 806.

In other words, with the benefit of compensation signal 628, voltage developed over R1 has the (compensation) effect to reduce magnitude of V_{REG} (i.e., voltage developed at the node between R2 and R3) over the rated range of input voltages for PFC 604, which is most pronounced at high-line input voltage (e.g., 285 VAC) as shown in FIG. 8 (i.e., where the shift is from about 2.8 V to about 2.0 V in the example where R3=6 MΩ, R2=30 kΩ and R1=0.1Ω). Such an effect in turn is the cause for the reduction in peak AC input current as shown in FIG. 3 where, as mentioned above, at high-line input voltage (e.g., 285 VAC) or, equivalently, the maximum input voltage of a rated range of input voltages for PFC 100 (e.g., 90-285 VAC), peak AC input current is reduced from that as shown by curve 302 (approximated shape/form), centered around 90° phase angle, to that as shown by curve 304 (approximated shape/form). At low-line input voltage (e.g., 90 VAC) or, equivalently, the minimum input voltage of the rated range of input voltages for PFC 100 (e.g., 90-285 VAC), peak AC input current is reduced from that as shown by curve 306 (approximated shape/form), centered around 90° phase angle, to that as shown by curve 308 (approximated shape/form), although the degree or extent (exaggerated in FIG. 3) by which peak AC input current is reduced at low-line input voltage is less than that by which peak AC input current is reduced at high-line input voltage. Advantageously, such a reduction in peak AC input current directly translates into improved performance of PFC 100 in terms of PF and THD.

As mentioned above, converter circuitry 102 of PFC 100 of FIG. 1 is arranged as a boost converter. Although, other power converter topologies are possible, and thus it is contemplated that controller circuitry 104 of FIG. 1 (and by extension controller circuitry of FIG. 6) may be coupled to any particular power converter topology, where type of power converter topology may be implementation-specific and may evolve as technology evolves. FIGS. 9-11 illustrate several example power converter topology types.

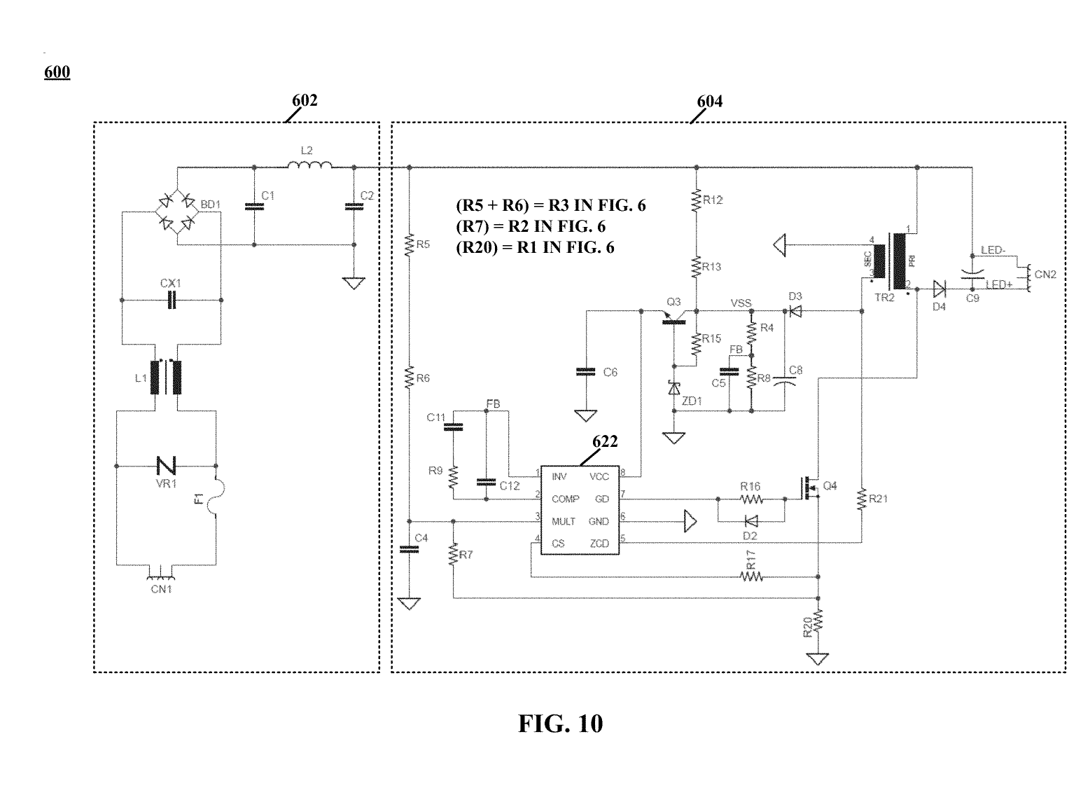

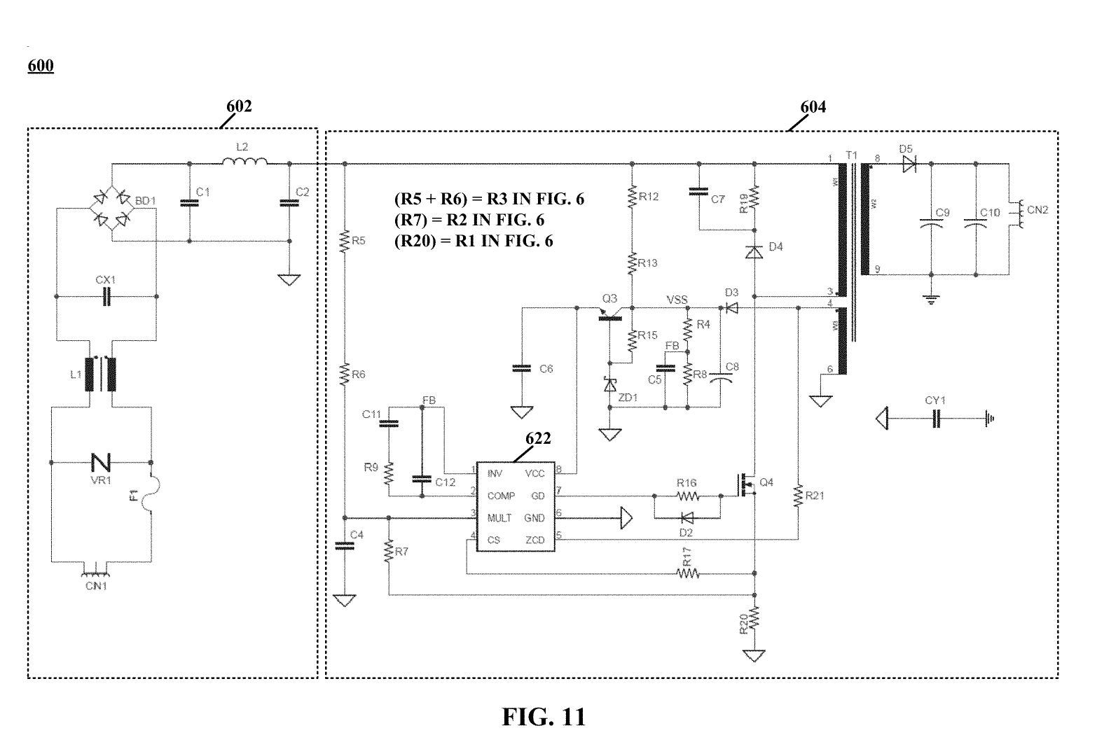

FIG. 9 shows SMPS 600 of FIG. 6, in part (without output block 606 and load 608), whereby converter circuitry of PFC 604 is arranged as a buck converter, as compared to FIG. 6 which shows converter circuitry of PFC 604 arranged as a boost converter. FIG. 10 shows SMPS 600 of FIG. 6, in part (without output block 606 and load 608), whereby converter circuitry of PFC 604 is arranged as a buck/boost converter, as compared to FIG. 6 which shows converter circuitry of PFC 604 arranged as a boost converter. FIG. 11 shows SMPS 600 of FIG. 6, in part (without output block 606 and load 608), whereby converter circuitry of PFC 604 is arranged as a fly-back converter, as compared to FIG. 6 which shows converter circuitry of PFC 604 arranged as a boost converter. Other examples are possible.

Additionally, the following numbered examples demonstrate one or more aspects of the disclosure.

### EXAMPLE 1

A power factor corrector circuit, comprising: converter circuitry that includes a switch; and controller circuitry that is coupled to the converter circuitry, wherein the switch of the converter circuitry is configured to deliver a signal to the controller circuitry to induce a voltage at an input of the controller circuitry to control conductive state of the switch and at a magnitude that is a function of an input voltage of the converter circuity. Such an implementation is discussed above in connection with at least FIG. 6 and FIG. 8.

### EXAMPLE 2

The power factor corrector circuit of example 1, wherein the converter circuitry is arranged as a boost converter. Such an implementation is discussed above in connection with at least FIG. 1 and FIG. 6.

### EXAMPLE 3

The power factor corrector circuit of any one of examples 1-2, wherein the converter circuitry is arranged as a buck converter. Such an implementation is discussed above in connection with at least FIG. 1 and FIG. 9.

### EXAMPLE 4

The power factor corrector of circuit any one of examples 1-3, wherein the converter circuitry is arranged as a buck/boost converter. Such an implementation is discussed above in connection with at least FIG. 1 and FIG. 10.

### EXAMPLE 5

The power factor corrector of circuit any one of examples 1-4, wherein the converter circuitry is arranged as a fly-back converter. Such an implementation is discussed above in connection with at least FIG. 1 and FIG. 11.

### EXAMPLE 6

The power factor corrector of circuit any one of examples 1-5, wherein the switch is a field-effect transistor. Such an implementation is discussed above in connection with at least FIG. 1 and FIG. 6.

### EXAMPLE 7

The power factor corrector circuit of any one of examples 1-6, wherein the controller circuitry comprises a resistive ladder network, the switch is configured to deliver current to the resistive ladder network, and the input of the controller circuitry is coupled to a node of the resistive ladder network. Such an implementation is discussed above in connection with at least FIG. 1 and FIG. 6.

### EXAMPLE 8

A switched-mode power supply, comprising: a filter; a power converter that includes a switch; and a power factor corrector circuit that is configured to receive an AC half-wave rectified input voltage from the filter and provide a DC output voltage to the power converter, wherein the power factor corrector circuit comprises converter circuitry and controller circuitry, and the switch of the power converter is configured to deliver a signal to the controller circuitry to induce a voltage at an input of the controller circuitry to control conductive state of the switch and at a magnitude that is a function of the AC half-wave rectified input voltage. Such an implementation is discussed above in connection with at least FIG. 6 and FIG. 8.

### EXAMPLE 9

The switched-mode power supply of example 8, wherein the converter circuitry is arranged as a boost converter. Such an implementation is discussed above in connection with at least FIG. 1 and FIG. 6.

### EXAMPLE 10

The switched-mode power supply of any one of examples 8-9, wherein the converter circuitry is arranged as a buck converter. Such an implementation is discussed above in connection with at least FIG. 1 and FIG. 9.

### EXAMPLE 11

The switched-mode power supply of any one of examples 8-10, wherein the converter circuitry is arranged as a buck/boost converter. Such an implementation is discussed above in connection with at least FIG. 1 and FIG. 10.

### EXAMPLE 12

The switched-mode power supply of any one of examples 8-11, wherein the converter circuitry is arranged as a fly-back converter. Such an implementation is discussed above in connection with at least FIG. 1 and FIG. 11.

### EXAMPLE 13

The switched-mode power supply of any one of examples 8-12, wherein the switch is a field-effect transistor. Such an implementation is discussed above in connection with at least FIG. 1 and FIG. 6.

### EXAMPLE 14

The switched-mode power supply of any one of examples 8-13, wherein the controller circuitry comprises a resistive ladder network, the switch is configured to deliver current to the resistive ladder network, and the input of the controller circuitry is coupled to a node of the resistive ladder network. Such an implementation is discussed above in connection with at least FIG. 1 and FIG. 6.

### EXAMPLE 15

The switched-mode power supply of any one of examples 8-14, further comprising a load coupled to the power converter. Such an implementation is discussed above in connection with at least FIG. 6.

### EXAMPLE 16

The switched-mode power supply of any one of examples 8-15, wherein the filter comprises a capacitor-input filter and a half-wave rectifier. Such an implementation is discussed above in connection with at least FIG. 6.

### EXAMPLE 17

The switched-mode power supply of any one of examples 8-16, wherein the power converter comprises a DC-DC power converter. Such an implementation is discussed above in connection with at least FIG. 6.

### EXAMPLE 18

A power factor corrector circuit, comprising: a power converter that includes a switch; a power factor controller; and a resistive ladder network that is coupled to the power converter and to the power factor controller, wherein a switch of the power converter is configured to deliver current to the power factor controller to induce a voltage at an input of the power factor controller, that is coupled to a node of the resistive ladder network, to control conductive state of the switch and at a magnitude that is a function of an input voltage of the power converter. Such an implementation is discussed above in connection with at least FIG. 1 and FIG. 6.

### EXAMPLE 19

The power factor corrector circuit of example 18, wherein the power converter is arranged as one of a boost converter, a buck converter, a buck/boost converter and a fly-back converter. Such an implementation is discussed above in connection with at least FIG. 1 and FIGS. 9-11.

### EXAMPLE 20

The power factor corrector circuit of any one of examples 18-19, wherein the switch is a metal-oxide-semiconductor field-effect transistor. Such an implementation is discussed above in connection with at least FIG. 1 and FIG. 6.

Various examples of the disclosure have been described. Any combination of the described systems, operations, or functions is contemplated. These and other examples are within the scope of the following claims.

1. A power factor corrector circuit, comprising:
converter circuitry that includes a switch; and
controller circuitry that is coupled to the converter circuitry,
wherein the switch of the converter circuitry is configured to deliver a signal to the controller circuitry to induce a voltage at an input of the controller circuitry to control conductive state of the switch, and wherein a magnitude of the voltage at the input of the controller circuitry is defined based on a rectified input voltage of the converter circuity.

2. The power factor corrector circuit of claim 1, wherein the converter circuitry is arranged as a boost converter.

3. The power factor corrector circuit of claim 1, wherein the converter circuitry is arranged as a buck converter.

4. The power factor corrector circuit of claim 1, wherein the converter circuitry is arranged as a buck/boost converter.

5. The power factor corrector circuit of claim 1, wherein the converter circuitry is arranged as a fly-back converter.

6. The power factor corrector circuit of claim 1, wherein the switch is a field-effect transistor.

7. The power factor corrector circuit of claim 1, wherein the controller circuitry comprises a resistive ladder network, the switch is configured to deliver current to the resistive ladder network, and the input of the controller circuitry is coupled to a node of the resistive ladder network.

8. A switched-mode power supply, comprising:
a filter;
controller circuitry; and
converter circuitry that includes a switch and that is coupled to the filter and the controller circuitry,
wherein the switch of the converter circuitry is configured to deliver a signal to the controller circuitry to induce a voltage at an input of the controller circuitry to control conductive state of the switch, and wherein a magnitude of the voltage at the input of the controller circuitry is defined based on an AC half-wave rectified input voltage of the converter circuitry.

9. The switched-mode power supply of claim 8, wherein the converter circuitry is arranged as a boost converter.

10. The switched-mode power supply of claim 8, wherein the converter circuitry is arranged as a buck converter.

11. The switched-mode power supply of claim 8, wherein the converter circuitry is arranged as a buck/boost converter.

12. The switched-mode power supply of claim 8, wherein the converter circuitry is arranged as a fly-back converter.

13. The switched-mode power supply of claim 8, wherein the switch is a field-effect transistor.

14. The switched-mode power supply of claim 8, wherein the controller circuitry comprises a resistive ladder network, the switch is configured to deliver current to the resistive ladder network, and the input of the controller circuitry is coupled to a node of the resistive ladder network.

15. The switched-mode power supply of claim 8, further comprising a load coupled to the power converter.

16. The switched-mode power supply of claim 8, wherein the filter comprises a capacitor-input filter and a half-wave rectifier.

17. The switched-mode power supply of claim 8, wherein the power converter comprises a DC-DC power converter.

18. A power factor corrector circuit, comprising:
a power converter that includes a switch;
a power factor controller; and
a resistive ladder network that is coupled to the power converter and to the power factor controller,
wherein the switch of the power converter is configured to deliver current to the power factor controller to induce a voltage at an input of the power factor controller, that is coupled to a node of the resistive ladder network, to control conductive state of the switch and at a magnitude that is defined based on a rectified a function of an input voltage of the power converter.

19. The power factor corrector circuit of claim 18, wherein the power converter is arranged as one of a boost converter, a buck converter, a buck/boost converter and a fly-back converter.

20. The power factor corrector circuit of claim 18, wherein the switch is a metal-oxide-semiconductor field-effect transistor.
